(19) United States
(12) Patent Application Publication
(10) Pub. No.: US 2013/0328882 A1
(43) Pub. Date: Dec. 12, 2013

(54) Named Area Generation

(71) Applicants: Imran A. Pirwani, Campbell, CA (US); Alexander Petrov, Campbell, CA (US)

(72) Inventors: Imran A. Pirwani, Campbell, CA (US); Alexander Petrov, Campbell, CA (US)

(73) Assignee: APPLE INC., Cupertino, CA (US)

(21) Appl. No.: 13/492,607

(22) Filed: Jun. 8, 2012

(51) Int. Cl. G06T 11/20; G06T 1/00

(52) U.S. Cl. 345/441; 345/522

(57) ABSTRACT

Systems, methods, and computer program products for named area generation are disclosed. In some implementations, documents are processed to uncover pairs of text strings and geographical regions (e.g., a collection of simple convex polygons). For any string/polygon pair, each polygon defines a geographical region whose name is the associated string.

### TECHNICAL FIELD

This disclosure relates generally to toponym recognition and construction.

### BACKGROUND

Modern mobile devices (e.g., smart phones, electronic tablets) often include a mapping application that allows a user of the mobile device to track their location and the location of other users on a geographic map display. The mapping applications may include a search engine to allow users to enter a search query to search for a particular point of interest, such as a business. The map display is usually generated from a map database that includes information for defining geographic boundaries for administrative areas (e.g., counties, cities, towns) based on geographic survey information. Such conventional map databases, however, are unable to identify regions of interest within the city boundaries, such as business districts (e.g., “Garment District”) or neighborhoods (e.g., “Russian Hill”). Nor do such conventional map databases provide colloquial named geographic regions (e.g., “Silicon Valley”) or pseudonyms for geographies (e.g., “Windy City”).

### SUMMARY

Systems, methods, and computer program products for named area generation are disclosed. A corpus of documents, including but not limited to photo captions with associated locations, phonebooks containing business listings, business cards, etc., are processed for structured spatial context data to uncover spatial structures that can be used to define regions of interest for map services (e.g., map display, map search). The spatial structures go beyond the information that is available in directory listings or as labels on maps/atlases.

In some implementations, each document in the corpus is associated with a geographic location (e.g., a latitude, longitude pair). The documents are processed to uncover pairs of text strings and geographical regions (e.g., a collection of simple polygons). For any string/multi-polygon pair, each polygon in the multi-polygon defines a geographical region whose name is the associated string. For example, if the collection contains the string/-multi-polygon pair (“Portland,” {poly1, poly2}), “poly 1” can accurately represent “Portland, Oreg.” and “poly2” can accurately represent “Portland, N.H.”

Particular implementations of named area generation disclosed herein provide one or more of the following advantages. A search engine or mapping application can use named area generation to provide an improved mapping services to a variety of applications. The map displays can include boundaries defining regions of interest that may be of more use to a user than administrative boundaries found in conventional map databases. A search engine or mapping application can provide a user with boundaries for neighborhoods, business districts, colloquial named geographical regions, pseudonyms for geographies.

The details of the disclosed implementations are set forth in the accompanying drawings and the description below. Other features, objects, and advantages will be apparent from the description and drawings, and from the claims.

### DESCRIPTION OF DRAWINGS

FIG. 1 illustrates a clustering of string/location pairs over geographic regions.

FIGS. 2A-2E illustrate k-means clustering and z-minimum spanning trees for generating and refining clusters of points.

FIG. 3 is a flow diagram of exemplary named area generation process.

FIG. 4 is an exemplary system for implementing the process of FIG. 3.

FIGS. 5A-5E illustrate exemplary convex polygons produced by the named area generation process of FIG. 3.

FIG. 6 is a block diagram of an exemplary operating environment capable of providing a networked-based mapping services that use named area generation processes.

FIG. 7 is a block diagram of an exemplary architecture of a device capable of running a search engine/mapping application that provides a mapping service that includes named areas generated by the process of FIG. 3.

The same reference symbol used in various drawings indicates like elements.

### DETAILED DESCRIPTION

Corpora such as Tweets™ with location, photo captions with associated locations, and phonebooks containing business listings, implicitly contain highly structured spatial context, which, when mined appropriately, can uncover spatial structures. For example, business names in a phonebook listing can contain useful toponym information, which, when aggregated appropriately with other listings, can uncover spatial structures such as neighborhoods, townships, etc. These structures go beyond the information that is typically available in directory listings or as labels on maps and atlases.

### A Problem Formulation

In one example problem formulation, we have as input to a named area generation process a collection of business cards, B, each of which contains a collection of names for a business and an associated geographic location (e.g., a latitude, longitude pair) for the business. It is desired that the named area generation process produce output in the form of a collection of records, each of which is a string/multi-polygon pair (e.g., a string and one or more disjoint, convex polygons), where each polygon in the multi-polygon accurately captures a geography with which the string can be meaningfully (non-trivially) associated. The named area generation process is performed in two phases as described below.

### Phase I—Collection of Points by Strings

Given an collection of business cards, B, each of which contains a collection of names (text strings) sᵢ for the business and an associated location p (e.g., latitude, longitude) for the business, we desire to output a collection of string/location pairs which can be represented mathematically by equation [1]:

C={(sᵢ,{pᵢⱼ}ⱼ₌₁ⁿ^{ᵢ})}ᵢ₌₁^{L} [1]

where pᵢⱼ is a point (e.g., a latitude, longitude pair), sᵢ is a string, L is the total number of strings, nᵢ is the number of points that are associated with the i^{th} string. The strings sᵢ are distinct in the collection C; that is for every i≠j, sᵢ≠sⱼ. This process can be described in pseudocode as follows:

```
for each business card b in B do
  for each name N for b do
    for each n-gram s do
      add the location of b to the collection of points associated with s to
      C
    endfor
  endfor
endfor
```

Phase I can be illustrated by the following example. Assume we have a first text string “Windy City Tires,” which was taken from a business card and is the name of a tire store in Chicago, Ill. The text string is associated with a geographic location in Chicago, Ill. In some implementations, an address may be included on the business card, which can be geocoded to provide a latitude, longitude pair (lat1, lon1) for the business location. Thus, without loss of generality, we assume a (lat, lon) pair for one business location. In Phase I, the text string can be broken down into a sequence of substrings (or n-gram) as follows:

### Windy

### Windy City

### Windy City Tires

### City

### City Tires

### Tires

Each of these substrings is associated with the location pair (lat1, lon1), which, in this example, defines a geographic location somewhere within the greater Chicago metropolitan area. Assume we have another text string “Windy City Pet Supplies,” which was taken from another business card and is the name of a pet store in Chicago. In Phase I, the text string can be broken down into substrings as follows:

### Windy

### Windy City

### Windy City Pet

### Wind City Pet Supplies

### City

### City Pet

### City Pet Supplies

### Pet

### Pet Supplies

### Supplies

Each of these substrings can be associated with a second latitude and longitude pair (lat2, lon2).

In this example, the two text strings have common substrings: Windy, Windy City and City. An example collection C of name/location pairs is: C={(Windy, {(lat1, lon1), (lat2, lon2)}), (Windy City, {(lat1, lon1), (lat2, lon2)}), (City, {(lat1, lon1), (lat2, lon2)} . . . }, where the common substrings Windy, Windy City and City are each associated with the locations (lat1, lon1) and (lat2, lon2). Accordingly, as a post condition to Phase I above, we now have a collection of string/location pairs, C={(s₁,{p₁₁, p₁₂, . . . }), (s₂, {p₂₁, p₂₂, . . . }), . . . }, where all sᵢ's are distinct in the collection.

In Phase II described below, each name/location pair of the collection, C, is processed independently from the other name/location pairs in the collection C.

### Phase II—Multi-Polygon Construction

In Phase II, given as input to the named area generation process a pair (sᵢ, {pᵢ₁, pᵢ₂, . . . , }) and a small set of parameters, ρ, we desire to output a small collection of convex polygons that cover a region of interest P to the extent specified by the parameters p. In some implementations, ρ=(k, min_sep, max_diam, pt_cov, frac_cov), where k is the maximum number of polygons and is assumed to be a small number, min_sep is the minimum separation between a pair of centers of polygons, max_diam is the maximum allowable diameter of a polygon, pt_cov is the fraction of the total points (locations) to be covered by the multi-polygons, and frac_cov is the fraction of points assigned to each of the Voronoi sets to be covered by the polygon. Some example parameters are ρ=(10, 30, 20, 0.25, 0.8), where the distance parameters min_sep, max_diam can be in miles or any other desirable unit of distance.

This Phase II process can be described in pseudocode as follows:

for every positive integer, k, up to a bound K specified in ρ do
sample a random partition of P into k Voronoi sets. Let D_k denote this partition
   for each of the k Voronoi sets in D_k, do
      find a small area convex polygon P_L with respect to parameters in ρ
   endfor
      If the collection of polygons, P_L is feasible with respect to p then output (s, {P_L}). Try the above random sampling “sufficiently many” (function of k) times independently to amplify the probability of finding an output that is constrained by ρ to a reasonably high level of probability, thus enabling the capture of polygons that are constrained by ρ, if such polygons exist.
         endfor

For example, given the example parameter set ρ=(10, 30, 20, 0.25, 0.8), the process considers a polygon collection that: (i) has at most 10 polygons; (ii) each pair of polygons are separated by at least 30 miles; (iii) each polygon has a diameter that does not exceed 20 miles; (iv) all polygons in a candidate solution set cover at least 25% of the total points; and (v) each polygon covers 80% of the points assigned to the Voronoi set from where it came.

The pseudocode described above for Phase I and II, can be implemented in any desired programming language, in firmware, hardware or a combination of software, firmware or hardware.

In some implementations, the partitioning of P into k Voronoi sets in Phase II can be implemented using a known planar k-means clustering algorithm, assuming a small value for k. For example, the region of interest P={p₁, p₂, . . . , pₙ} can be a 2-dimensional real vector with n points that can be partitioned into k sets (k≦n) S={S₁, S₂, . . . , Sₖ} so as to minimize the within-cluster sum of squares (WCSS),

$${arg min}_{S} {\sum }_{i = 1}^{k} {\sum }_{{x}_{j} ∈ {S}_{i}} {‖ {x}_{j} - {μ}_{i} ‖}^{2} , \qquad [ 2 ]$$

where μᵢ is the mean of points in Sᵢ.

An iterative refinement technique can be used to implement [2] (e.g., Lloyd's algorithm). Given a set of k means, mᵢ⁽¹⁾, . . . , mₖ⁽¹⁾, the algorithm can proceed by alternating between an assignment (expectation) step and an update (maximization) step.

Assignment Step: In the assignment step, each point xₚ (observation)) is assigned to a cluster with the closest mean mᵢ, resulting in the points being partitioned into Voronoi sets generated by the means mᵢ:

Sᵢ^{(t)}={xₚ:∥xₚ−mᵢ^{(t)}∥≦∥xₚ−mⱼ^{(t)}∥∀1≦j≦k} [3]

where each point xₚ goes into exactly one Voronoi set Sᵢ^{(t)}, even if it could go into two Voronoi sets.

Update Step: In the update step, a new means is calculated to be the centroid of the points in the cluster:

$${m}_{i}^{( t + 1 )} = \frac{1}{\vert {s}_{i}^{( t )} \vert} {\sum }_{{x}_{j} ∈ {s}_{i}^{( t )}} {x}_{j} . \qquad [ 4 ]$$

The planar k-means algorithm described by [3] and [4] is deemed to have converged when the assignment of points to clusters no longer changes much or when a maximum number of allowable items is reached. The planar k-means algorithm can be initialized using, for example, the well-known Random Partition method. The Random Partition method first randomly assigns a cluster to each observation and then proceeds to the update step, thus computing the initial means to be the centroid of the cluster's randomly assigned points. Other initialization methods can be used including but not limited to the well-known Forgy method.

The planar k-means clustering algorithm described by [3] and [4] can be summarized by the following steps:

1. randomly select k initial means (e.g., k=3) from the points provided by Phase I;
2. generate k clusters by associating every point with a nearest mean;
3. determine the centroid of each of the k clusters;
4. set the mean of each cluster to be the centroid for that cluster; and
5. repeat steps 2-4 until convergence has been reached.

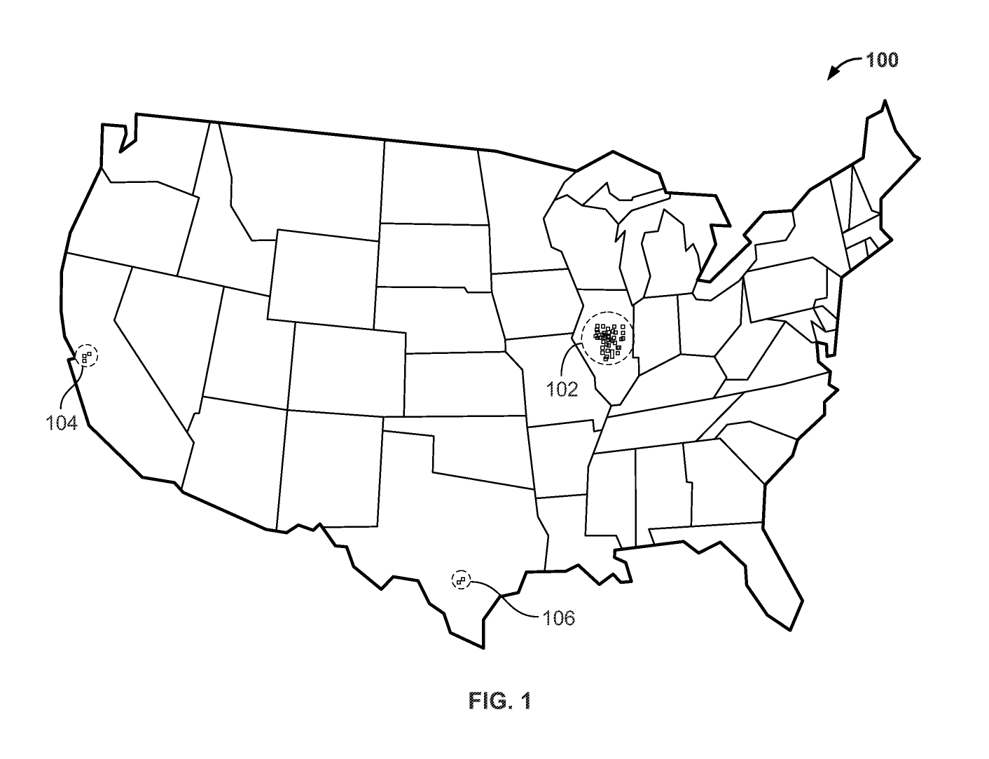

FIG. 1 illustrates clustering of data points over geographic regions. Continuing with the “Windy City” example described above, the results of applying the planar k-means algorithm to the substring “Windy City” produced three clusters of points 102, 104, 106 on map 100. Cluster 102 is located on map 100 overlying the Chicago metropolitan area and includes a large number of densely packed points. Cluster 104 overlies Northern California and includes a small number of points relative to cluster 102. Cluster 106 overlies Texas and includes a small number of points relative to clusters 102 and 104. Each of these clusters is associated with the string “Windy City.” The densest cluster is cluster 102 overlying the Chicago metropolitan area, as is expected for this example. Clusters 104, 106 can be discarded as noise based on the low number of points. For these clusters, the string “Windy City” could be associated with the name of a pizzeria called Windy City Pizza, but other than selling Chicago style pizza, has nothing to do with Chicago.

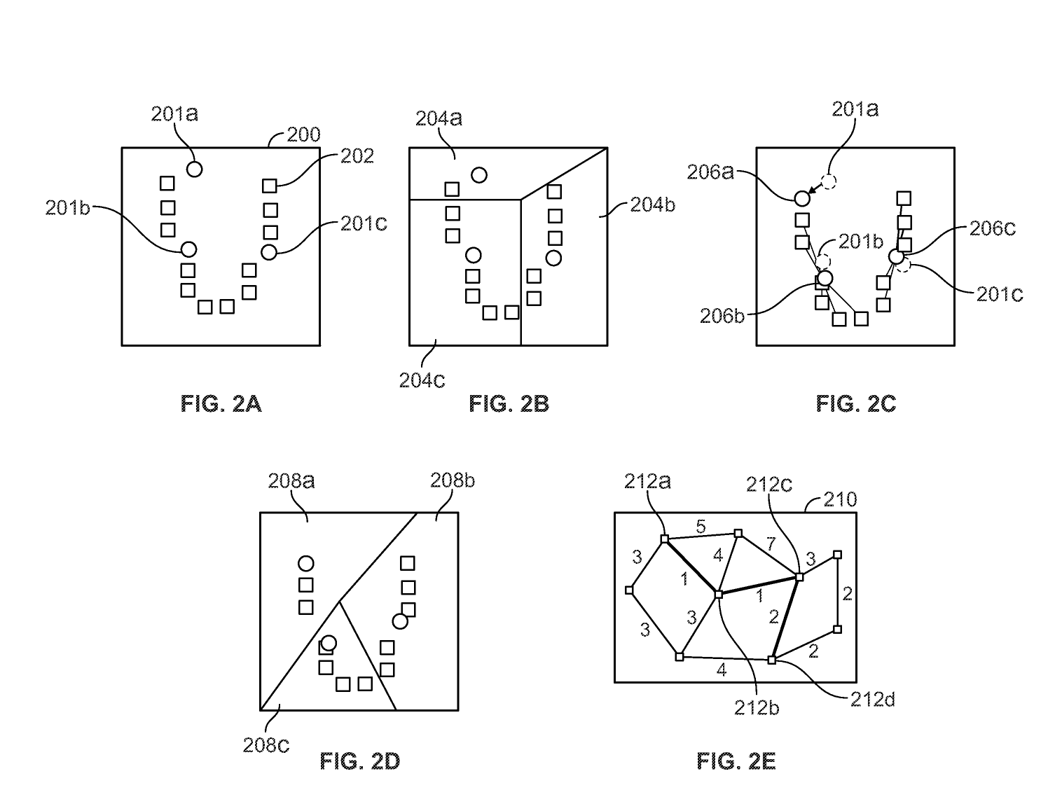

FIGS. 2A-2D illustrate the k-means algorithm applied to an individual string/location pair, resulting from Phase I. For each string/location pair, the location is represented by a set of points (e.g., a latitude, longitude pair) that collectively define a region of interest P. In the following description, the black squares represent the points in the region of interest and the circles represent means.

In FIG. 2A, k initial means are randomly selected from the points in a region of interest P defined by the locations in the string/location pair. In this example, k=3. In FIG. 2B, k clusters are created by associating every point with a nearest mean. This results in the creation of partitions also referred to as Voronoi sets 204a, 204b and 204c. The centroid of each of the k clusters becomes the new means, as shown in FIG. 2C. Steps 2 and 3 are then repeated, resulting in Voronoi sets 208a, 208b and 208c. The k-means algorithm proceeds in an iterative manner until convergence has been reached (e.g., the assignment of points to clusters no longer changes).

After the clustering step in Phase II, the resulting clusters may not be “tight” enough to generate good polygons. Clusters can be made tighter by computing an average point (e.g., average latitude and longitude pair) from the points in the cluster and then discarding from the cluster any points that are greater than a desired distance from the average point.

In some implementations, an L-minimum spanning tree can be used to create tighter clusters. For the L-minimum spanning tree algorithm, a connected, undirected graph can be created from the points in the original cluster produced in Phase II. The spanning tree of a undirected graph is a subgraph or subtree that connects all the vertices together of the undirected graph. Each line segment connecting two vertices is called an edge or path. A weight can be assigned to each edge, which can be a number representing how unfavorable the edge is with respect to a cost function β, and these edge or path weights can be used to assign a weight to the spanning tree by computing the sum of the weights of the edges or paths. The edge costs between a pair of points is the distance between them. The cost of a set of points is the area of the smallest polygon that covers the set.

For our purposes we seek a smallest L and a corresponding L-MST, which results in L points. The convex hull of these L points can be a proxy for the cheapest polygon. In some implementations, the cost β can be represented by β=num*x/100, where num is the total number of points in the cluster and x is the percentage of num points to be included in the new and “tighter” cluster (e.g., 80%). Once the tighter cluster of points has been created, a polygon can be created from the points using any suitable publicly known convex hull algorithm, including but not limited to: Gift Wrapping (Jarvis's March algorithm), Graham Scan, QuickHull, divide and conquer, monotone chain, marriage-before-conquest and Chan's algorithm.

FIG. 2E illustrates a L-MST for refining point clusters. Given an undirected graph G=(Vertices, Edges) with non-negative edge costs and positive integer L, the L-MST of G is a tree with minimum cost that spans exactly L vertices of G. In some implementations, a L-MST algorithm can be used to span a subset of L vertices in the undirected graph with minimum weight. In this example, the edge weights represent relative distances between points. The edges can be represented by units of distance to reduce the edge weights to small integers. A 4-MST is illustrated in FIG. 2E. In this example, vertices 212a, 212b, 212c and 212d are included in a minimum weight path (1+1+2=4) through undirected graph 210.

Using the L points of the L-MST, we generate a polygon which is the convex hull of the L points.

### Exemplary Process

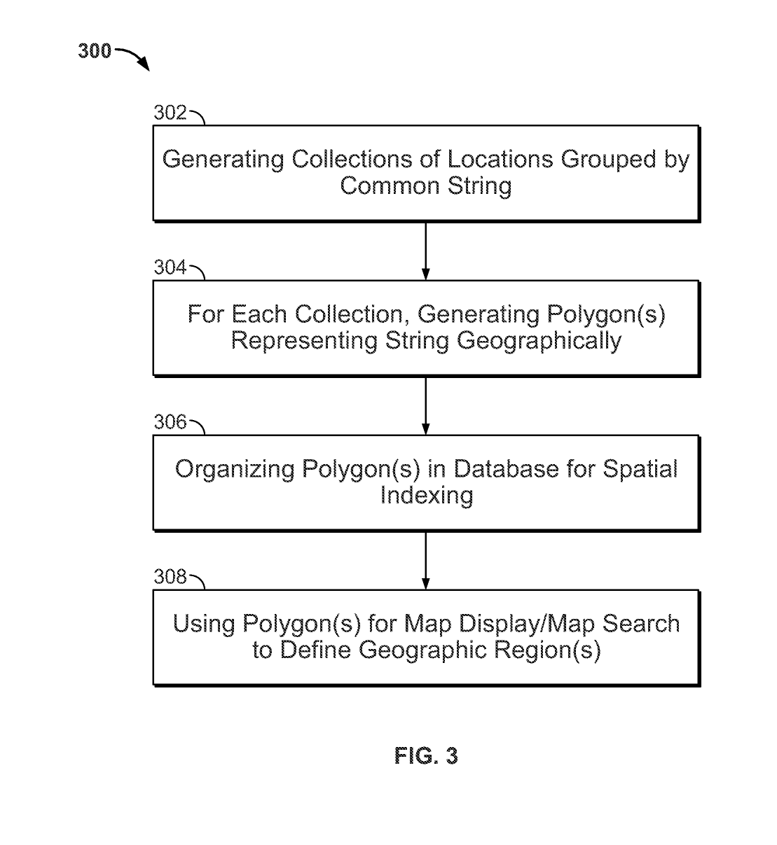

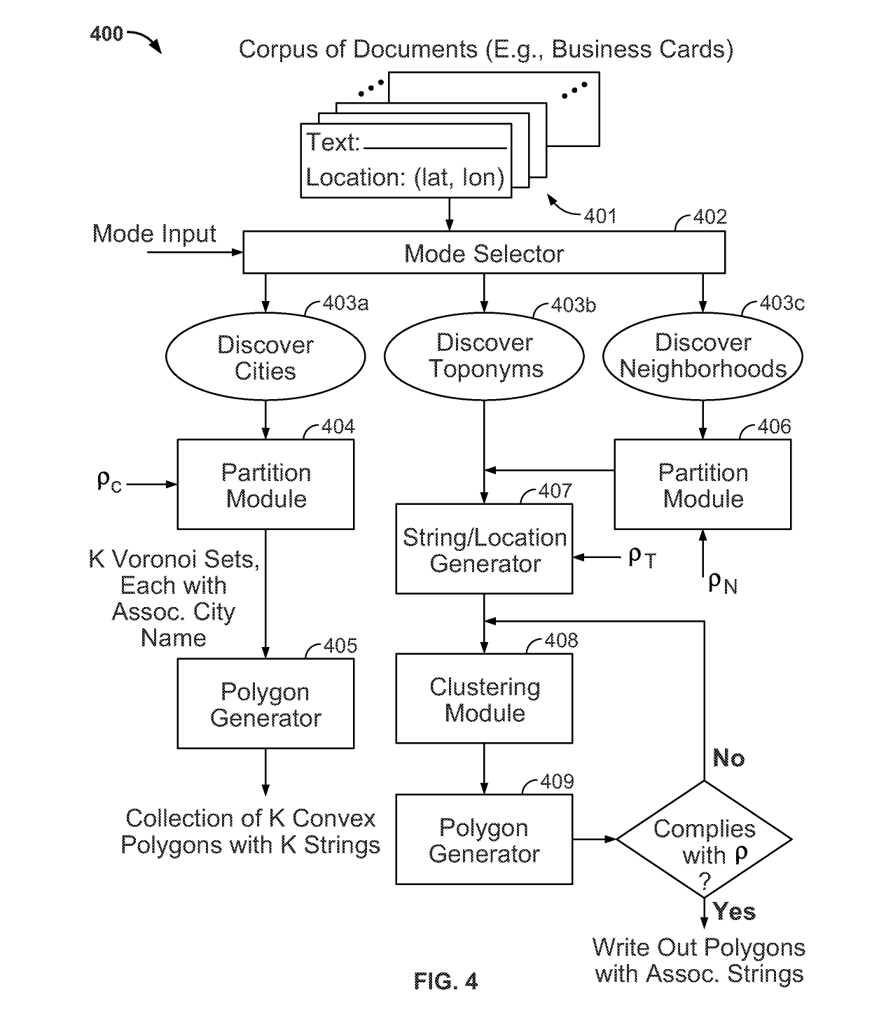

FIG. 3 is a flow diagram of exemplary named area generation process 300. Process 300 can be implemented using system 400, as described in reference to FIG. 4.

Process 300 can begin by generating collections of locations grouped by a common string (302). For example, a collection can be generated using equation [1].

For each collection, process 300 can generate one or more polygons representing the common string geographically (304). In some implementations, the polygons can be determined based on the clustering of points around geographic regions of interest. For example, planar k-means clustering as described in [3] and [4] can be used to form clusters around geographic regions of interest. The clusters can be refined to be tighter and have a better shape using the averaging or L-MST algorithms described above.

Process 300 can continue by organizing the one or more polygons in a database for spatial indexing (306). The database of polygons can be used for various mapping services to define one or more geographic regions (308). Mapping services can include but are not limited to map display and map search. Mapping services using named area generation can be used in an intelligent personal assistant or knowledge navigator system with a voice command interface.

### Exemplary System

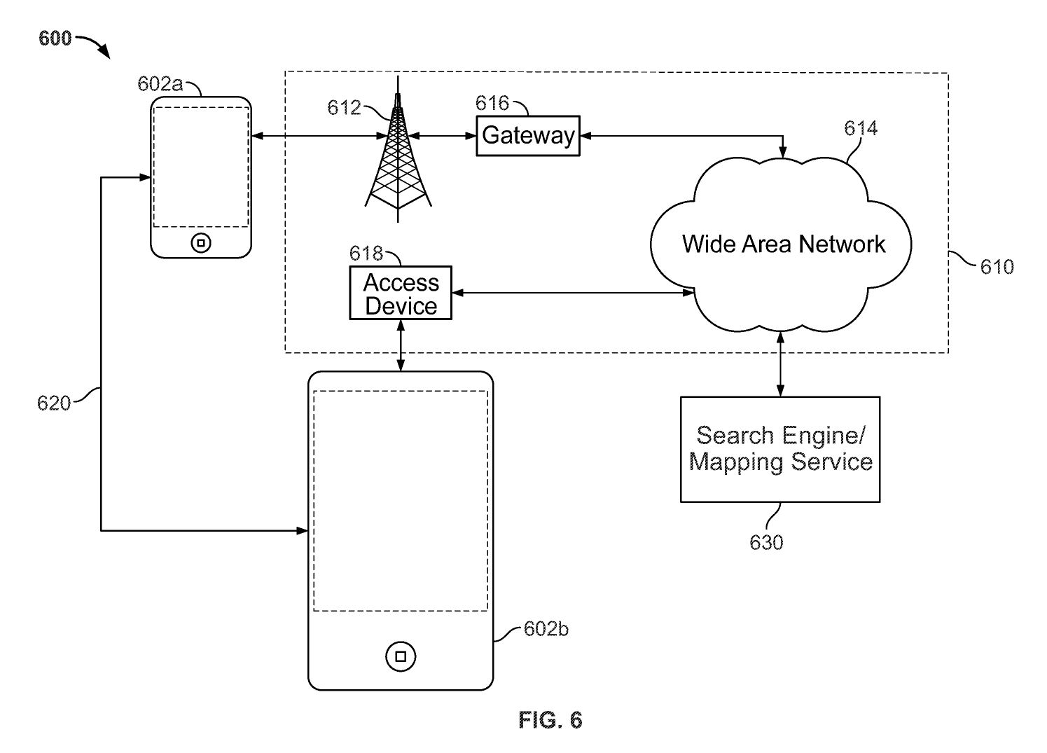

FIG. 4 is an exemplary system 400 for implementing the process of FIG. 3. System 400 can be implemented in software and/or hardware on a single computer or on multiple computers operating in client/server architecture using one or more server computers, as described in reference to FIG. 6. In some implementations, system 400 can include document corpus 401, mode selector 402, partition modules 404, 406, string/location pair generator 407, clustering module 408 and polygon generators 405, 409.

Mode selector 402 can receive input from a user or application for selecting a processing mode. The input can be, for example, a search request from a user or application to discover cities, toponyms, pseudonyms, colloquial names/regions or neighborhoods. Depending on the input, one of three processing modes will be entered: discover cities mode 403a, discover toponyms mode 403b or discover neighborhoods mode 403c.

Mode selector 402 processes corpus 401 of documents according to the mode selected. A document in corpus 401 is a document that includes one or more text strings and is associated with a geographic location, such as a latitude, longitude pair. In the example shown, corpus 401 includes business cards. Each individual business card can have one or more text strings, which can provide spatial context information. An example text string is “Windy City Tires.” Corpus 401 can include other types of documents such as phone directory listings.

In some implementations, location information taken from a document (e.g., taken from a business card or directory listing) can be determined by converting a street address to a latitude, longitude pair using geocoding. An example method of geocoding is address interpolation that makes use of data from a street geographic information system (GIS). Each street segment is mapped to an address range (e.g., house numbers from one segment to the next). Geocoding takes an address and matches it to a street and specific street segment (e.g., a block in a town). Geocoding interpolates the position of the address (e.g., a latitude, longitude pair) within the range along the street segment.

### Discover Cities Mode

In discover cities mode 403a, locations are partitioned into k Voronoi sets (404) by partition module 404. Each of the k Voronoi sets is associated with a city name. The partitioning can be based on a set of parameters ρ_{c} as described above. The parameter set ρ_{c} is input to partition module 404 and places constraints on how the partitions will be generated. Some example parameters for ρ_{c} can include specifying the geographic locations of the centers of cities in the partitions, specifying the maximum diameters of partitions and specifying the percentage of points (e.g., latitude, longitude pairs) that are covered in a given block.

The k Voronoi sets are input into polygon generator 405. Polygon generator 405 constructs a convex polygon for each of the k sets independently using a convex hull algorithm. In some implementations, an L-MST algorithm can be used to find L vertices, the convex hull of which is a proxy for the cheapest polygon. The output of polygon generator 405 is a collection of k convex polygons with k strings that comply with “ρ_{c},” which is the set of parameters that is specific to discovering metropolitan areas.

### Discover Toponyms Mode

In discover toponyms mode 403b, string/location generator 407 constructs a collection of string/location pairs according equation [1]. The discover toponyms mode 403b is selected for requests to discover toponyms, pseudonyms and colloquial names/regions.

In some implementations, string/location generator 407 receives parameter set ρ_{T}, which provides constraints on the collections to be generated, such as the number of polygons to be generated and the percentage of points to be covered in a given block. Each collection is then processed by clustering module 408. In some implementations, clustering module 408 implements a clustering algorithm (e.g., k-means clustering) on each collection of string/location pairs to obtain k Voronoi sets using, for example, equations [3] and [4]. The k Voronoi sets are then processed by polygon generator 409.

Polygon generator 409 operates in a manner similar to polygon generator 405 and can use the same code. The output of polygon generator 409 is a collection of k convex polygons with k strings. The polygons are checked after each cycle of the clustering algorithm to determine if the polygons comply with the constraints imposed by parameter set ρ_{T}. If the polygons do not comply with the constraints imposed by ρ_{T}, clustering module 408 performs additional clustering cycles on the collection, iteratively, until the one or more polygons comply with the constraints imposed by ρ_{T}.

### Discover Neighborhoods Mode

In discover neighborhoods mode 403c, partition module 406 partitions corpus 401 by cities according to an input parameter set ρ_{N}. For each block of a partition generated by partition module 406, the process steps of discover toponym mode 403b are performed as previously described. Some example parameters for parameter set ρ_{N} can include a maximum number of city polygons, a maximum diameter of a polygon and a percentage of points covered by each polygon.

### Exemplary Applications

The named area generation process described above can be used in a variety of applications, including but not limited to automatic detection of commercial concepts of city boundaries, discovery of colloquial named geographical regions (informal names), discovery of neighborhoods and discovery of pseudonyms for geographies. These applications are described below.

### Automatic Detection of Commercial Concept of City Boundaries

In general, the number of distinct cities having a given name is small. This allows the parameter k in Phase II to be made. If the point-set P contains few good clusters, then a random subset of k points can be chosen uniformly and independently from “dense” subsets of the point-set. If P contains k dense regions, then a tractable number of independent random trials will have one point chosen from each of the k clusters with reasonably high probability, leading to a good clustering, which forms a good “initial” guess. The problem can then be reduced to filtering out the “noise” in each of the k Voronoi sets.

### Discovery of Colloquial Named Geographical Region (Informal Name)

A named region, which is not necessarily a formally recognized administrative region, is often used to refer to a geographical landmark. Some examples of these are “Silicon Valley,” “Bay Area,” “Wine Country,” “Central Valley,” “East Bay,” etc. These named regions are commonly referred to in colloquial speech, yet are not well defined by maps or atlases. The named area generation processes described above (Phase I and Phase II) can capture these colloquial named regions from the strings of the string/polygon pairs.

### Discovery of Neighborhoods

By appropriately setting some control parameters, ρ, defined above, polygons can be generated that represent neighborhoods such as “Russian Hill,” “Waikiki,” “Dolores Park,” etc.

### Discovery of Pseudonyms for Geographies

The name area generation processes (Phase I, Phase II) described above can generate polygons for “Windy City,” “Sin City,” “Mile High,” etc., as was demonstrated by the “Windy City” example above.

### Exemplary Named Regions

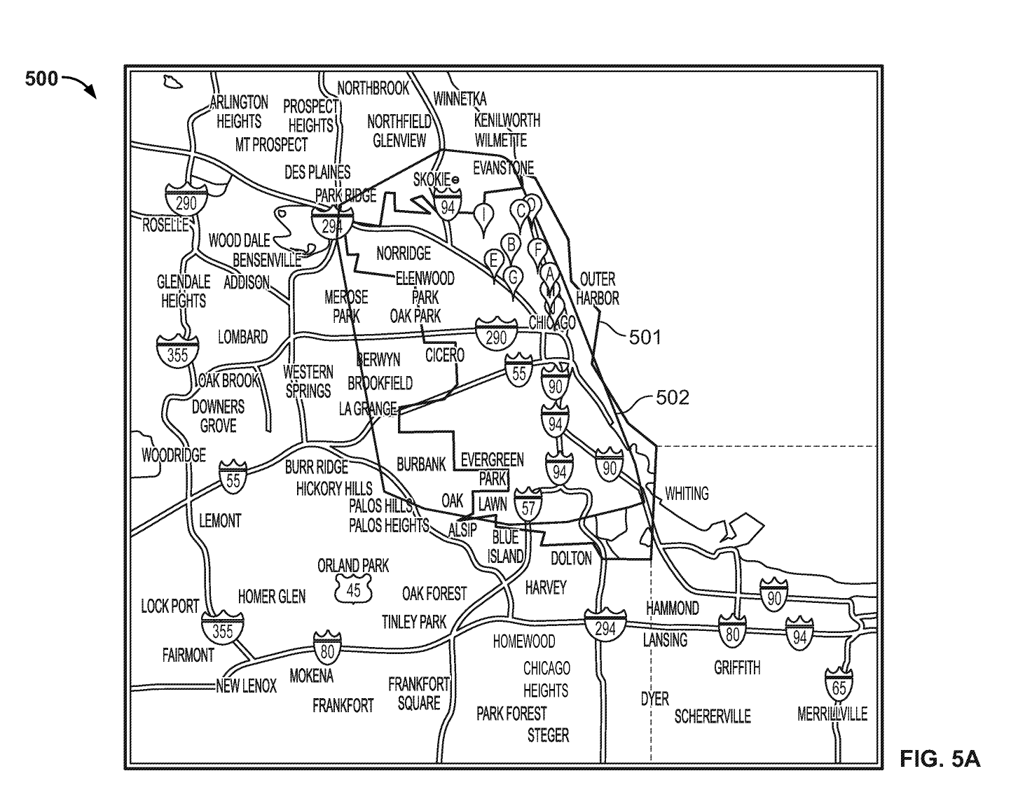

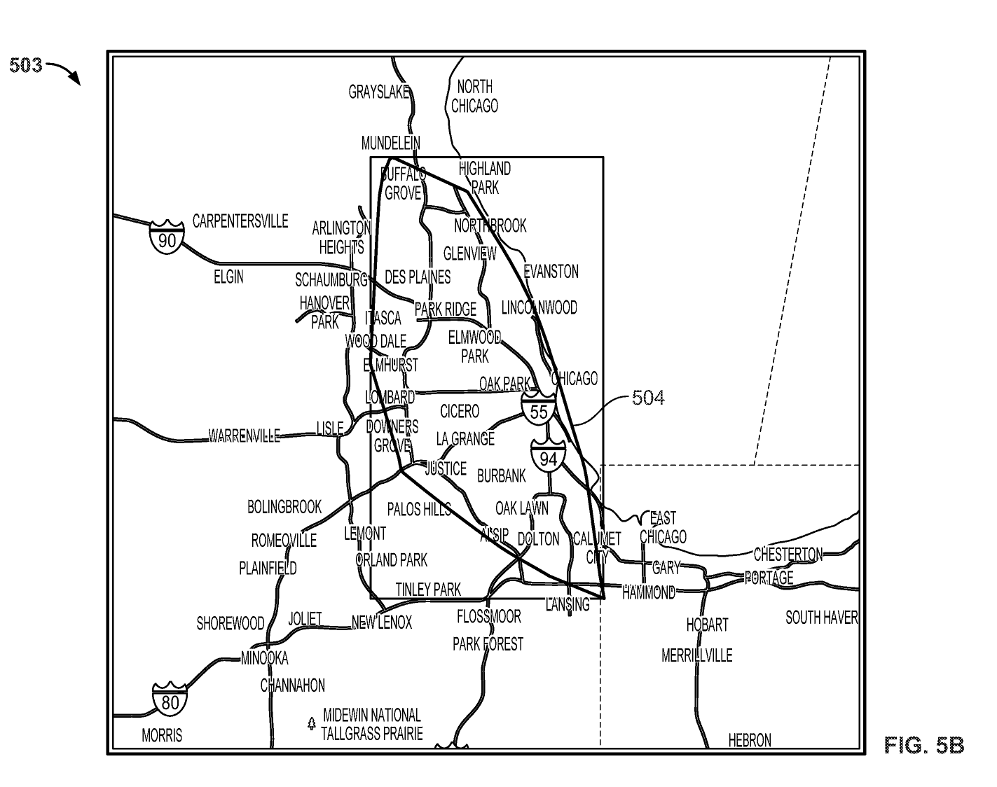

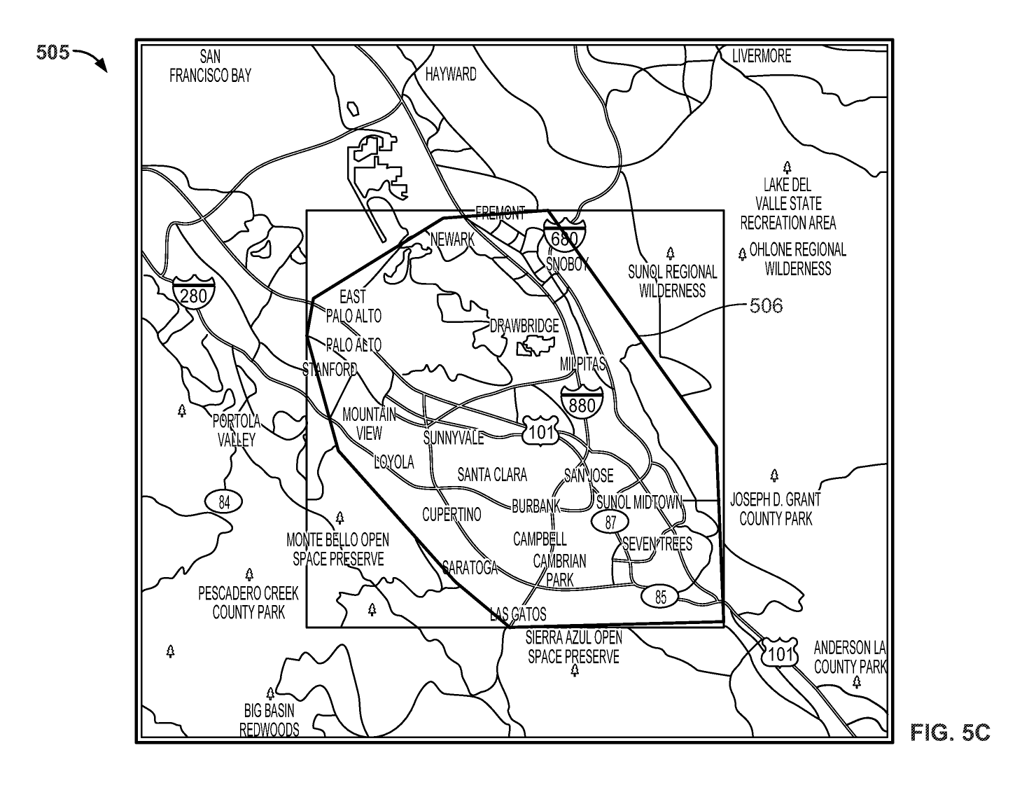

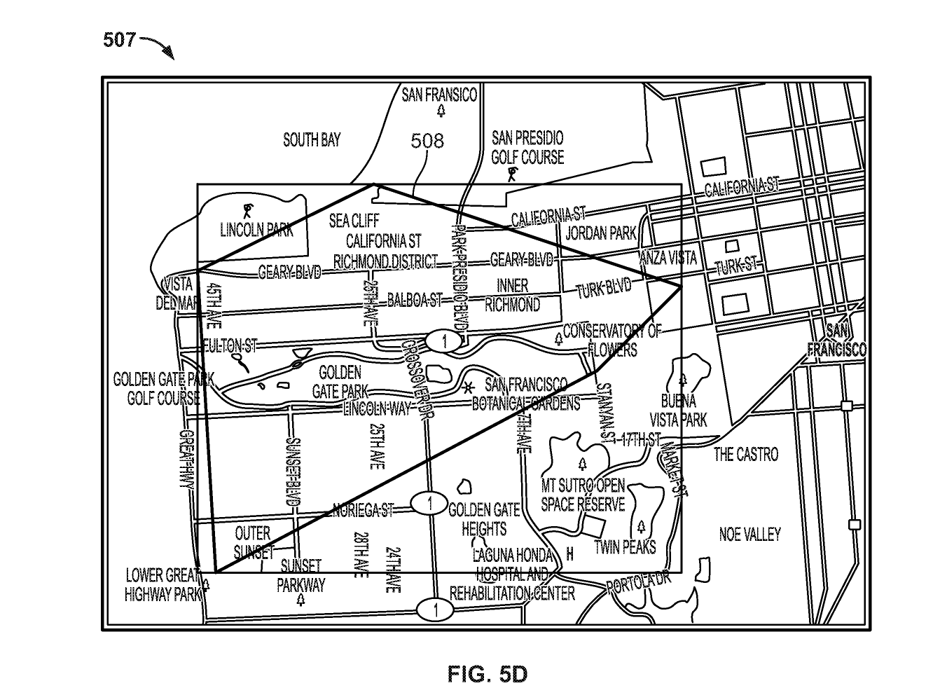

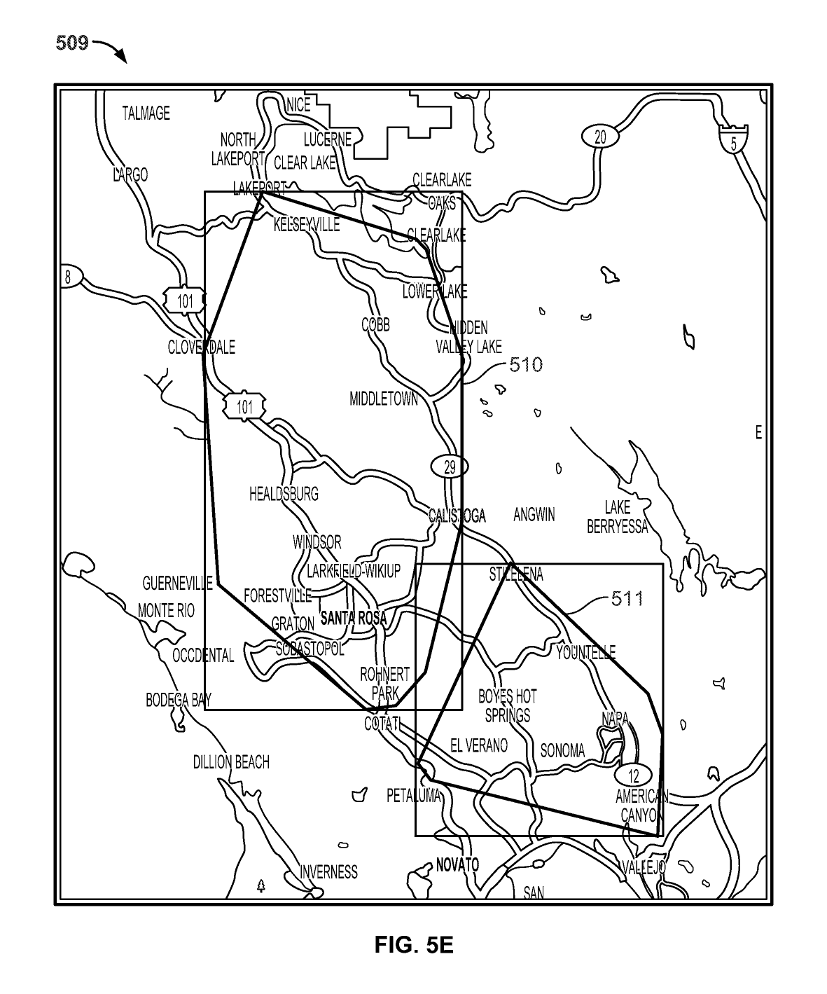

FIGS. 5A-5E illustrate exemplary convex polygons produced by the named area generation process 300 described above.

Referring to FIG. 5A, map display 500 illustrates the result of process 300 operating in “discover cities” mode. Region 502 is the result of process 300 based on the string: “Chicago.” Region 501 is a region determined by administrative boundaries.

Referring to FIG. 5B, map display 503 illustrates the result of process 300 operating in “discover toponyms” mode. Region 504 is the result of process 300 based on the text string: “windy city” (a colloquial name for Chicago).

Referring to FIG. 5C, map display 505 illustrates the result of process 300 operating in “discover toponyms” mode. Region 506 is the result of process 300 based on the text string: “silicon valley” (a toponym).

Referring to FIG. 5D, map display 507 illustrates the result of process 300 operating in “discover neighborhood” mode. Region 508 is the result of process 300 based on the text string: “golden gate park.” (a neighborhood located in San Francisco).

Referring to FIG. 5E, map display 509 illustrates result of process 300 operating in “discover toponym” mode. Regions 510 and 511 are the results of process 300 based on the text string: “wine country.” This example illustrates the generation of more than one polygon to cover two regions that comprise “Wine Country.’

### Exemplary Operating Environment

FIG. 6 is a block diagram of an exemplary operating environment capable of providing a networked-based search engine/mapping application that uses named area generation.

In some implementations, devices 602a and 602b can communicate over one or more wired or wireless networks 610. For example, wireless network 612 (e.g., a cellular network) can communicate with a wide area network (WAN) 614 (e.g., the Internet) by use of gateway 616. Likewise, access device 618 (e.g., IEEE 802.11g wireless access device) can provide communication access to WAN 614. Devices 602a, 602b can be any device capable of displaying GUIs of the disclosed content authoring application, including but not limited to portable computers, smart phones and electronic tablets. In some implementations, the devices 602a, 602b do not have to be portable but can be a desktop computer, television system, kiosk system or the like.

In some implementations, both voice and data communications can be established over wireless network 612 and access device 618. For example, device 602a can place and receive phone calls (e.g., using voice over Internet Protocol (VoIP) protocols), send and receive e-mail messages (e.g., using SMPTP or Post Office Protocol 3 (POP3)), and retrieve electronic documents and/or streams, such as web pages, photographs, and videos, over wireless network 612, gateway 616, and WAN 614 (e.g., using Transmission Control Protocol/Internet Protocol (TCP/IP) or User Datagram Protocol (UDP)). Likewise, in some implementations, device 602b can place and receive phone calls, send and receive e-mail messages, and retrieve electronic documents over access device 618 and WAN 614. In some implementations, device 602a or 602b can be physically connected to access device 618 using one or more cables and access device 618 can be a personal computer. In this configuration, device 602a or 602b can be referred to as a “tethered” device.

Devices 602a and 602b can also establish communications by other means. For example, wireless device 602a can communicate with other wireless devices (e.g., other devices 602a or 602b, cell phones) over the wireless network 612. Likewise, devices 602a and 602b can establish peer-to-peer communications 620 (e.g., a personal area network) by use of one or more communication subsystems, such as the Bluetooth™ communication devices. Other communication protocols and topologies can also be implemented.

Devices 602a or 602b can communicate with service 630 over the one or more wired and/or wireless networks 610. For example, service 630 can be a search engine and/or mapping application that performs at least a portion of the named area generation process 300 described in reference to FIG. 3.

Device 602a or 602b can also access other data and content over one or more wired and/or wireless networks 610. For example, content publishers, such as news sites, Really Simple Syndication (RSS) feeds, Web sites and developer networks can be accessed by device 602a or 602b. Such access can be provided by invocation of a web browsing function or application (e.g., a browser) running on the device 602a or 602b.

Devices 602a and 602b can exchange files over one or more wireless or wired networks 610 either directly or through service 630.

### Exemplary Device Architecture

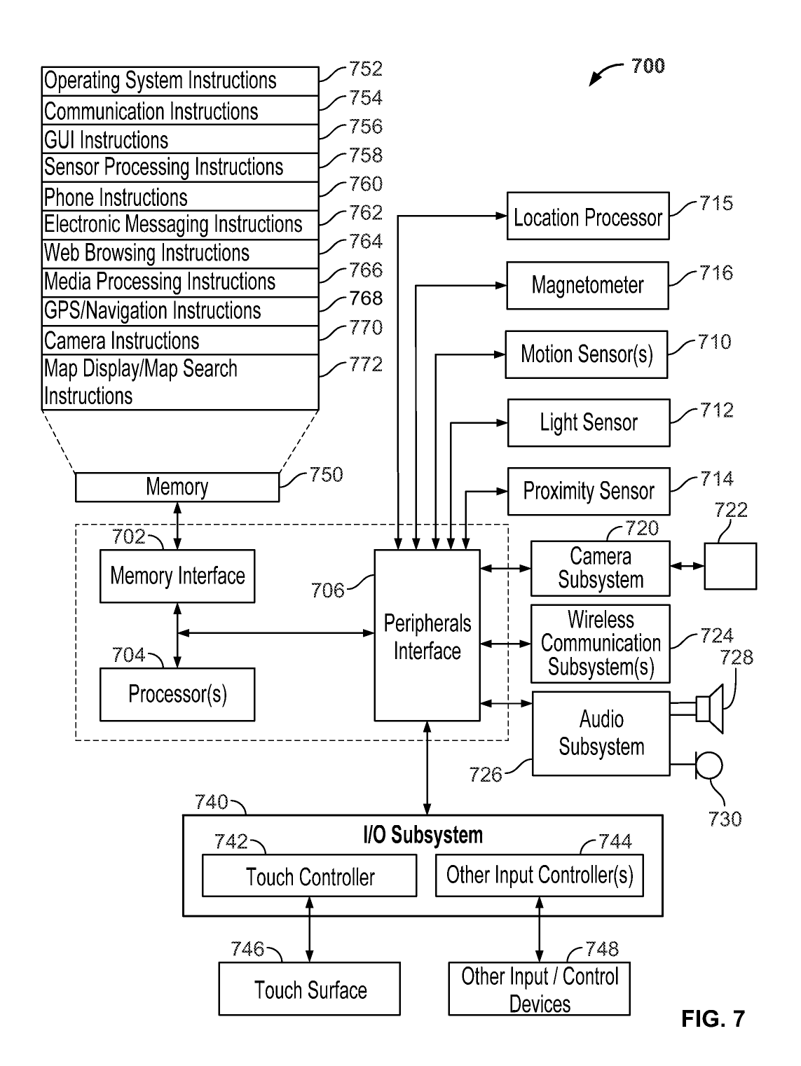

FIG. 7 is a block diagram of an exemplary architecture of a device capable of running a search engine/mapping application that generates a map display that includes named areas generated by the process of FIG. 3.

Architecture 700 can be implemented in any device for generating the features described in reference to FIGS. 1-4, including but not limited to portable or desktop computers, smart phones and electronic tablets, television systems, game consoles, kiosks and the like. Architecture 700 can include memory interface 702, data processor(s), image processor(s) or central processing unit(s) 704, and peripherals interface 706. Memory interface 702, processor(s) 704 or peripherals interface 706 can be separate components or can be integrated in one or more integrated circuits. The various components can be coupled by one or more communication buses or signal lines.

Sensors, devices, and subsystems can be coupled to peripherals interface 706 to facilitate multiple functionalities. For example, motion sensor 710, light sensor 712, and proximity sensor 714 can be coupled to peripherals interface 706 to facilitate orientation, lighting, and proximity functions of the device. For example, in some implementations, light sensor 712 can be utilized to facilitate adjusting the brightness of touch surface 746. In some implementations, motion sensor 710 (e.g., an accelerometer, gyros) can be utilized to detect movement and orientation of the device. Accordingly, display objects or media can be presented according to a detected orientation (e.g., portrait or landscape).

Other sensors can also be connected to peripherals interface 706, such as a temperature sensor, a biometric sensor, or other sensing device, to facilitate related functionalities.

Location processor 715 (e.g., GPS receiver) can be connected to peripherals interface 706 to provide geo-positioning. Electronic magnetometer 716 (e.g., an integrated circuit chip) can also be connected to peripherals interface 706 to provide data that can be used to determine the direction of magnetic North. Thus, electronic magnetometer 716 can be used as an electronic compass.

Camera subsystem 720 and an optical sensor 722, e.g., a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 724. Communication subsystem(s) 724 can include one or more wireless communication subsystems. Wireless communication subsystems 724 can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The specific design and implementation of the communication subsystem 724 can depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., Wi-Fi, Wi-Max, or 3G networks), code division multiple access (CDMA) networks, and a Bluetooth™ network. Communication subsystems 724 may include hosting protocols such that the device may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 726 can be coupled to a speaker 728 and one or more microphones 730 to facilitate voice-enabled functions, such as voice recognition, voice replication, digital recording, and telephony functions.

I/O subsystem 740 can include touch controller 742 and/or other input controller(s) 744. Touch controller 742 can be coupled to a touch surface 746. Touch surface 746 and touch controller 742 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 746. In one implementation, touch surface 746 can display virtual or soft buttons and a virtual keyboard, which can be used as an input/output device by the user.

Other input controller(s) 744 can be coupled to other input/control devices 748, such as one or more buttons, rocker switches, thumb-wheel, infrared port, USB port, and/or a pointer device such as a stylus. The one or more buttons (not shown) can include an up/down button for volume control of speaker 728 and/or microphone 730.

In some implementations, device 700 can present recorded audio and/or video files, such as MP3, AAC, and MPEG files. In some implementations, device 700 can include the functionality of an MP3 player and may include a pin connector for tethering to other devices. Other input/output and control devices can be used.

Memory interface 702 can be coupled to memory 750. Memory 750 can include high-speed random access memory or non-volatile memory, such as one or more magnetic disk storage devices, one or more optical storage devices, or flash memory (e.g., NAND, NOR). Memory 750 can store operating system 752, such as Darwin, RTXC, LINUX, UNIX, OS X, WINDOWS, or an embedded operating system such as VxWorks. Operating system 752 may include instructions for handling basic system services and for performing hardware dependent tasks. In some implementations, operating system 752 can include a kernel (e.g., UNIX kernel).

Memory 750 may also store communication instructions 754 to facilitate communicating with one or more additional devices, one or more computers or servers. Communication instructions 754 can also be used to select an operational mode or communication medium for use by the device, based on a geographic location (obtained by the GPS/Navigation instructions 768) of the device. Memory 750 may include graphical user interface instructions 756 to facilitate graphic user interface processing, such as the maps shown in FIGS. 4A-4J; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 768 to facilitate GPS and navigation-related processes; camera instructions 770 to facilitate camera-related processes and functions; and mapping application 772 that is capable of displaying maps with convex polygons generated by process 300, and as shown in FIGS. 1-4. The memory 750 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 750 can include additional instructions or fewer instructions. Furthermore, various functions of the mobile device may be implemented in hardware and/or in software, including in one or more signal processing and/or application specific integrated circuits.

The features described can be implemented in digital electronic circuitry or in computer hardware, firmware, software, or in combinations of them. The features can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer can communicate with mass storage devices for storing data files. These mass storage devices can include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with an author, the features can be implemented on a computer having a display device such as a CRT (cathode ray tube) or LCD (liquid crystal display) monitor for displaying information to the author and a keyboard and a pointing device such as a mouse or a trackball by which the author can provide input to the computer.

The features can be implemented in a computer system that includes a back-end component, such as a data server or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a LAN, a WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an Application Programming Interface (API). An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. The systems and techniques presented herein are also applicable to other electronic text such as electronic newspaper, electronic magazine, electronic documents etc. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
generating collections of locations grouped by a common string; and
for each collection, generating one or more polygons representing the common string geographically,
wherein the method is performed by one or more hardware processors.

2. The method of claim 1 further comprising:
organizing the one or more polygons in a database for spatial indexing;

3. The method of claim 2, further comprising:
using the database for a mapping service to define one or more geographic regions.

4. The method of claim 1, where generating collections of locations grouped by a common string further comprises:
generating collections of locations grouped by a common string according to the equation
C={(sᵢ,{pᵢⱼ}ⱼ₌₁ⁿ^{ᵢ})}ᵢ₌₁^{L},
where pᵢⱼ is a location, sᵢ is a string, L is a total number of strings, nᵢ is the number of points that are associated with the i^{th} string, and the strings sᵢ are distinct in the collection C, such that for every i≠j, sᵢ≠sⱼ.

5. The method of claim 1, where generating polygons further comprises:
performing a first process to each collection to generate one or more clusters of locations.

6. The method of claim 5, where the first process is k-means clustering, where k is a small positive integer.

7. The method of claim 6, further comprising:
performing a second process on at least one cluster to modify the shape of the cluster.

8. The method of claim 7, where the second process uses a L-minimum spanning tree (L-MST), where L is a positive integer.

9. The method of claim 1, where the polygons are generating based on a set of parameters including one or more of: i) the maximum number of polygons, the minimum separation between a pair of centers of polygons, ii) the maximum allowable diameter of a polygon, iii) the fraction of the total points that the polygon will cover, and iv) the fraction of points assigned to the polygon that the polygon will cover.

10. A system comprising:
one or more processors;
memory coupled to the one or more processors and configured to store instructions, which, when executed by the one or more processors, causes the one or more processors to perform operations comprising:
generating collections of locations grouped by a common string; and
for each collection, generating one or more polygons representing the common string geographically.

11. The system of claim 10 where the memory stores instructions, which, when executed by the one or more processors, causes the one or more processors to perform operations comprising:
organizing the one or more polygons in a database for spatial indexing;

12. The system of claim 11, where the memory stores instructions, which when executed by the one or more processors, causes the one or more processors to perform operations comprising:
using the database for a mapping service to define one or more geographic regions.

13. The system of claim 10, where generating collections of locations grouped by a common string further comprises:
generating collections of locations grouped by a common string according to the equation
C={(sᵢ,{pᵢⱼ}ⱼ₌₁ⁿ^{ᵢ})}ᵢ₌₁^{L},
where pᵢⱼ is a location, sᵢ is a string, L is a total number of strings, nᵢ is the number of points that are associated with the i^{th} string, and the strings sᵢ are distinct in the collection C, such that for every i≠j, sᵢ≠sⱼ.

14. The system of claim 10, where generating polygons further comprises:
performing a first process to each collection to generate one or more clusters of locations.

15. The system of claim 14, where the first process is k-means clustering, where k is a small positive integer.

16. The system of claim 15, where the memory stores instructions, which when executed by the one or more processors, causes the one or more processors to perform operations comprising:
performing a second process on at least one cluster to modify the shape of the cluster.

17. The system of claim 16, where the second process uses a L-minimum spanning tree (L-MST), where L is a positive integer.

18. The system of claim 10, where the polygons are generating based on a set of parameters including one or more of: i) the maximum number of polygons, the minimum separation between a pair of centers of polygons, ii) the maximum allowable diameter of a polygon, iii) the fraction of the total points that the polygon will cover, and iv) the fraction of points assigned to the polygon that the polygon will cover.

19. A non-transitory computer-readable storage medium storing instructions, which, when executed by one or more processors, causes the one or more processors to perform operations comprising:
generating collections of locations grouped by a common string; and
for each collection, generating one or more polygons representing the common string geographically,
wherein the method is performed by one or more hardware processors.

20. The computer-readable medium of claim 19 further including instructions, which, when executed by the one or more processors, causes the one or more processors to perform the operation of:
organizing the one or more polygons in a database for spatial indexing;
